(19) United States
(12) Patent Application Publication
(10) Pub. No.: US 2020/0259301 A1
(43) Pub. Date: Aug. 13, 2020

(54) PLUG CONNECTOR

(71) Applicant: PHOENIX CONTACT GMBH & CO. KG, Blomberg (DE)

(72) Inventors: Carsten SCHMITZ, Blomberg (DE); Fredrik BRAND, Schieder-Schwalenberg (DE)

(21) Appl. No.: 16/649,536

(22) PCT Filed: Sep. 7, 2018
(86) PCT No.: PCT/EP2018/074198

§ 371 Date: Mar. 20, 2020

(30) Foreign Application Priority Data
Sep. 21, 2017 (DE) 10 2017 121 937.4

(51) Int. Cl. H01R 29/00; H01R 13/66; H01R 13/717

(52) U.S. Cl. CPC H01R 29/00; H01R 13/6691; H01R 13/7175; H01R 13/6675; H01R 13/6683

(57) ABSTRACT

A plug connector, having a housing that has at least one slot for accommodating an exchangeable function module. The housing is configured for accommodating a supply unit and/or a locking unit in order to fasten the function module to the housing in a form-fit and/or force-fit manner.

### FIELD

The present invention relates to a plug connector.

### BACKGROUND

Plug connectors are used for accommodating one or more cable ends in order to establish a detachable, electrically conductive plug-in connection with a mating piece, such as a socket or the like, having a shape that is complementary to the plug connector.

It is known to provide additional functions, for example temperature monitoring, on such a plug connector. For this purpose, for example a temperature sensor may be adhesively bonded to a housing part of the plug connector. It is disadvantageous that the temperature sensor bonded to the housing part cannot be nondestructively exchanged or replaced with a sensor having some other function, for example current or voltage measurement, or a status display. In addition, such approaches do not allow measurement of operating parameters within the plug connector, i.e., in the direct vicinity of the metallic contact parts of the plug connector.

Against this background, the present invention is based on the technical object of providing an improved plug connector.

The invention relates to a plug connector having a housing that has at least one slot for accommodating an exchangeable function module, wherein the housing is configured for accommodating a supply unit and/or a locking unit in order to fasten the function module to the housing in a form-fit and/or force-fit manner.

With the aid of the slots, the plug connector may thus be equipped as needed with sensors in a flexible manner. Thus, a plug connector that initially has no function modules may be purchased by an end customer if the exact intended purpose or the necessary measurement tasks are still uncertain. The plug connector may be retrofitted with function modules if necessary.

The plug connector may therefore be configured in particular to be usable independently of an installed function module or an installed supply unit and/or locking unit. In this case, the plug connector thus forms a base module that is usable by itself as a conventional plug connector, without a function module or a supply unit and/or locking unit. Due to the fact that the plug connector may be designed as a plug connector that is conventionally usable by itself without an additional function, the plug connector may be used alone as a base unit, without an additional function, with no additional cost to the end customer. The housing of the plug connector may be equipped with additional functions, as needed, by means of one or more function modules.

The supply unit may be a module that is likewise replaceably securable to the housing, and that has a control, evaluation, and/or communication electronics system for controlling and/or supplying power to one or more function modules, and via which one or more function modules may be fastened to the housing in a form-fit and/or force-fit manner.

As an alternative or in addition to the supply unit, the locking unit may be provided for the form-fit and/or force-fit fastening of one or more function modules to the housing. The locking unit may be designed strictly as a fastening module without an integrated control, evaluation, and/or communication electronics system. If such a locking unit is used for fastening one or more function modules, one or more function modules may be configured to be coupleable to an external control, evaluation, and/or communication electronics system that is separate from the plug connector.

According to another embodiment, a plug connector is provided, having at least one exchangeable function module that is accommodated in the slot, and having an exchangeable supply unit, wherein the supply unit is configured for supplying power to the function module and/or for transmitting signals between the function module and a control unit, and wherein the supply unit has at least one molded element that is configured for fastening the function module to the housing in a form-fit manner. According to this embodiment, the plug connector with the housing, the exchangeable supply unit, and the at least one exchangeable function module therefore has an at least three-part design. The at least one function module, which may contain, for example, one or more sensors and/or one or more status displays, and the supply unit are formed as separate, exchangeable individual parts to allow the plug connector to be equipped in each case with the necessary function module on an application-specific basis. Thus, a modular plug connector is provided which may be flexibly used.

The plug connector is in particular configured for accommodating one or more cable ends in order to establish a detachable, electrically conductive plug-in connection with a mating piece, such as a socket or the like, having a shape that is complementary to the plug connector. The housing may have one or more cable terminals, for example, for accommodating cable ends and securing to the housing, for example via a screw connection or clamp connection.

In addition to supplying power to the function module and/or transmitting signals, the supply unit with its at least one molded element is also used to fasten the function module to the housing in a form-fit and/or force-fit manner. It is possible to exchange the function module in particular only when the supply unit has been at least partially or completely removed from the housing, and the function module is thus de-energized. In this way, due to the structural design of the plug connector it may be ensured that exchange of the function module takes place only in its de-energized state.

The at least one slot for accommodating a function module may be designed as a receptacle, in the manner of a blind hole, that is open toward the surroundings of the plug connector, so that function modules may be easily inserted into the plug connector. This embodiment allows simple, prompt maintenance of the plug connector, for example if defective function modules must be exchanged or replaced with some other type of function modules, or for the case that function modules are to be retrofitted on the housing.

The plug connector may have a plurality of slots.

According to another embodiment of the plug connector, it is provided that the molded element of the supply unit is used for contacting the function module with the supply unit, in particular, that the molded element is part of a bus system. The functional integration of the contacting and the form-fit connection in the molded element allow a compact design of the plug connector, so that additional cabling between the function module and the supply unit may be dispensed with.

The molded element may contain an electrically conductive material or may be made of an electrically conductive material. The molded element may thus be used for securing or holding the function module to/on the housing, and in addition to the form-fit connection, for establishing an electrically conductive connection between the function module and the supply unit for the power supply and/or signal transmission.

It may be provided that the molded element has at least one pin, or is made up of a pin, that is situated in openings in the housing and in the function module. A form-fit connection for fastening the function module to the housing may thus be provided in a simple and cost-effective manner.

The pin may be, for example, a projecting metal pin that may have an essentially circular, rectangular, or square cross-sectional shape, for example. It is understood that the pin may have an oval, triangular, or star-shaped cross-sectional shape, for example, depending on the application and the available installation space. The openings in the housing and in the function module may have a shape that is complementary to the pin cross section in order to easily achieve a form-fit connection.

If two or more function modules are to be fastened in two or more slots of the housing, it may be provided that a single molded element is used for the form-fit connection of all function modules to the housing, in which the molded element passes through all openings in the function modules and in the housing. A plurality of function modules may thus be fastened to the housing in a form-fit manner by use of a single molded element that is provided on the supply unit.

Alternatively or additionally, at least two molded elements, in particular exactly two molded elements, may be provided that are situated in openings in the housing of the function module. A reliable and stable form-fit connection may be achieved by providing at least two or exactly two molded elements in cooperation with the openings.

To prevent the function module from being installed in an incorrect position or orientation, at least two openings that are provided on the function module may be introduced into the function module in an asymmetrical or eccentric manner, so that incorrect installation of a function module inside the housing is prevented by structural specifications.

If two or more molded elements, in particular exactly two molded elements, are provided, the molded elements may in each case be projecting metal pins, or projecting pins that are electrically conductive or provided with an electrically conductive coating, wherein the pins may have a circular, oval, rectangular, triangular, square, or star-shaped cross-sectional shape, for example, as described above.

To allow simple installation and deinstallation of the function modules, according to another embodiment of the plug connector the openings in the housing and in the function modules are situated coaxially, or have concentrically situated cross sections, viewed along an axis, so that the openings in the housing and in the function module are in flush alignment and may be easily penetrated by a single molded element that originates from the supply unit. If two or more molded elements are provided, two or more rows of aligned openings may be provided, each of which is penetrated by an associated molded element.

It may be provided that the openings and the pin have a circular cylindrical shape. A reliable form-fit connection may thus be established in a simple and cost-effective manner.

It may be provided that a clearance fit is formed between the openings and the molded element. The plug connector may thus be easily assembled without, for example, having to cool the molded elements or heat the housing in the area of the openings.

According to another embodiment of the plug connector, it is provided that the function module is insertable into the slot along an insertion direction, and a longitudinal extension of the molded element is oriented transversely with respect to the insertion direction, in particular essentially orthogonally with respect to the insertion direction. In this way, the function modules may, for example, be lined up adjacently and secured to the housing by inserting one molded element or multiple molded elements transversely with respect to the insertion direction.

A molded element may have a length that is greater than or equal to a width, measured transverse to the insertion direction, of all lined-up function modules. In particular, a molded element may have a length that is greater than or equal to a width of the housing measured transverse to the insertion direction.

The supply unit is configured for supplying power to the function module and/or for transmitting signals between the function module and a control unit.

The supply unit may have control means such as a microcontroller or the like. Alternatively or additionally, the supply unit may have an RFID tag. Alternatively or additionally, the supply unit may have one or more sensors such as a temperature sensor or the like. Alternatively or additionally, the supply unit may have a status display such as an LED or the like. Alternatively or additionally, the supply unit may have a voltage converter. Alternatively or additionally, the supply unit may have an analog/digital converter. Accordingly, the supply unit may have a plurality of functions in order to cooperate with the function module.

The function module may be a sensor module. Such a sensor module may be configured, for example, for monitoring an operating temperature of the plug connector or of the plug-in connection to be established with the plug connector. Alternatively or additionally, the function module may have a humidity sensor, for example. Alternatively or additionally, the function module may have a status display, for example to signal an intact or interrupted galvanic connection for one or more cable terminals of the plug connector. It may be provided that such sensors are integrated into a function module or distributed over multiple function modules of the plug connector, each situated in a separate slot of the plug connector.

It may be provided that two or more slots and/or two or more function modules are provided.

To achieve the most compact incorporation possible of a function module or multiple function modules into the housing, the function module may be at least partially or completely integrated into an installation space of the housing. This ensures that, despite the integration of additional functions, for the plug connector no larger, or only slightly larger, installation space is necessary on a circuit board, for example. Function modules may thus also be used for applications or designs that were originally configured only for use of a conventional plug connector without an additional function.

Alternatively or additionally, it may be provided that the function module or at least one of the function modules rests with a first section against a first side of a housing wall, and with a second section is associated with a second side of the housing wall facing away from the first side, wherein the second section is not integrated into an installation space of the housing. This embodiment allows a more compact design of the housing, so that if no function modules are installed, the housing itself may also be used for applications that provide a comparatively small installation space for a plug connector.

According to another embodiment of the plug connector, it is provided that the slot is associated with a pole and is open toward a cable terminal side. It may thus be ensured that the function module is removable and installable in the area of the cable terminal side.

The slot may adjoin a metallic contact element that is configured for conducting current during operation of the plug connector. Thus, for example, function modules may be used that tap or detect parameters of the electrically conductive connection directly at metallic contact elements of the plug connector. A contact bar that rests against a sensor and against a contact element that conducts current during operation of the plug connector may thus be associated with the sensor.

It may be provided that the supply unit has an enclosure that rests against an outer surface of the housing facing away from the contact element. Thus, the supply unit may, for example, be installed laterally with respect to a cable terminal side and a plug-in connection side facing away from the cable terminal side, so that the supply unit does not hinder either the connection of cables to the plug connector, or installation/deinstallation of the plug connector in a complementarily shaped receptacle or socket. The molded element or the molded elements may extend starting from a side of the enclosure facing the plug connector, and may pass through the housing and the at least one function module.

It may be provided that the supply unit is connected to the housing in a form-fit and/or force-fit manner. For example, a screw connection or clamp connection may be provided to secure the supply unit to the housing. An economical, detachable connection between the housing and the supply unit may be provided in this way.

It may be provided that a function module occupies a single slot. Alternatively or additionally, it may be provided that a function module is configured to be accommodated in two or more slots. The function module may be designed in the manner of a bridge having protrusions that are accommodated in two or more slots, wherein a single function module accordingly occupies two or more slots.

A function module may have an interface, such as a cable or the like, via which the function module is coupleable to an external power supply and/or control system and/or data link. The function module may thus be operable via an external power supply, independently of or in addition to a supply unit of the plug connector.

### BRIEF DESCRIPTION OF THE DRAWINGS

The invention is described in greater detail below with reference to drawings based on one embodiment, which schematically show the following:

FIG. 1A shows a plug connector according to the invention in a perspective view from above;

FIG. 1B shows the plug connector from FIG. 1A in a side view;

FIG. 1C shows the plug connector from FIG. 1A in a rear view;

FIG. 1D shows a section along the line D-D from FIG. 1C;

FIG. 2A shows another plug connector according to the invention in a perspective view from above;

FIG. 2B shows the plug connector from FIG. 2A in a side view;

FIG. 2C shows the plug connector from FIG. 2A in a rear view;

FIG. 2D shows a section along the line D-D from FIG. 2C;

FIG. 3A shows another plug connector according to the invention in a perspective view from above;

FIG. 3B shows a housing of the plug connector from FIG. 3A in a perspective view from above;

FIG. 3C shows a supply unit of the plug connector from FIG. 3A in a perspective view from above; and

FIG. 3D shows a function module of the plug connector from FIG. 3A in a perspective view from above.

### DETAILED DESCRIPTION

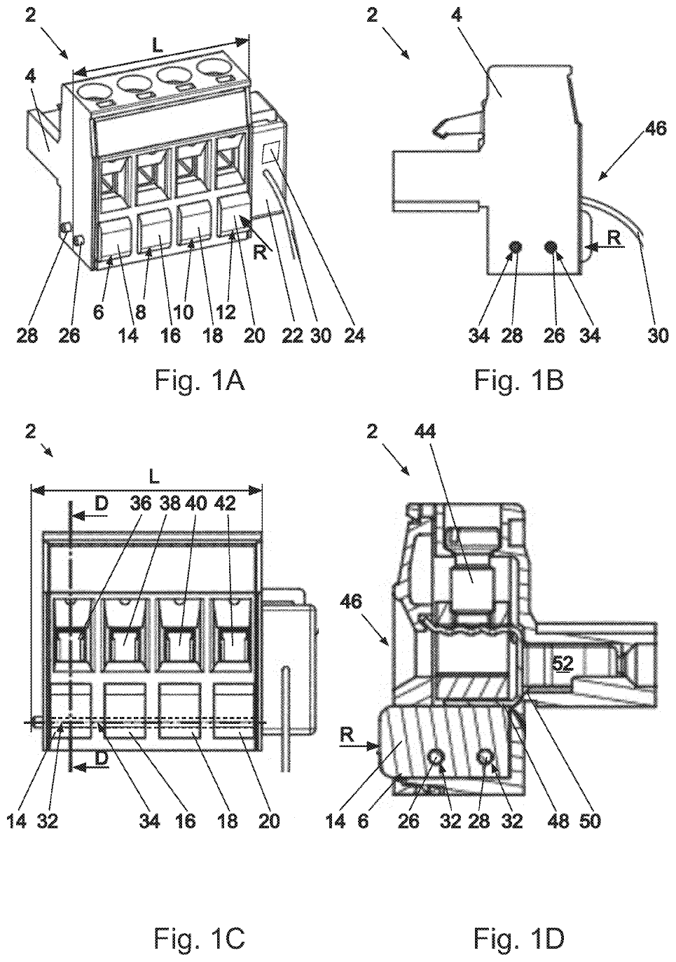

FIG. 1A shows a plug connector 2. The plug connector 2 has a housing 4.

The housing 4 has four slots 6, 8, 10, 12 for accommodating function modules 14, 16, 18, 20, respectively. The function modules 14, 16, 18, 20 are exchangeably accommodated in the respective slots 6, 8, 10, 12.

In addition, the plug connector 2 has an exchangeable supply unit 22. The supply unit 22 is configured for supplying power to the function modules 14, 16, 18, 20 and for transmitting signals between the function modules 14, 16, 18, 20 and a control unit 24, in the present case the control unit 24 being integrated into the supply unit 22.

The supply unit 22 in the present case has two molded elements 26, 28 that are configured for fastening the function modules 14, 16, 18, 20 to the housing 4 in a form-fit manner.

The molded elements 26, 28 of the supply unit 22 are configured for contacting the function modules 14, 16, 18, 20 with the supply unit 22. Accordingly, the molded elements 26, 28 are used for fastening the function modules 14, 16, 18, 20 to the housing 4 and also for establishing an electrically conductive connection of the function modules 14, 16, 18, 20 to the supply unit 22.

The molded elements 26, 28 of the supply unit 22 are part of a bus system (not illustrated), the supply unit 22 being connectable to the bus system via the line 30.

The molded elements 26, 28 in the present case are designed as pins 26, 28 that have a circular cross section and are provided in coaxially situated through openings 32, 34 in the housing 4 and in the function modules 14, 16, 18, 20. A first row of aligned openings 32, 34 is associated with the pin 26. A second row of aligned openings 32, 34 is associated with the pin 28.

A clearance fit is formed between the openings 32, 34 and the pins 26, 28.

The function modules 14, 16, 18, 20 are insertable into their respective slot 6, 8, 10, 12 along an insertion direction R, as shown for the function module 14 by way of example.

In the present case, a longitudinal extension L of the molded elements or pins 26, 28 is oriented orthogonally with respect to the insertion direction R.

The supply unit 22 in the present case has a microcontroller, an RFID tag, a temperature sensor, a status display, a voltage converter, and an analog/digital converter. It is understood that according to further exemplary embodiments, one or more analog/digital converters may be an integral part of the microcontroller.

In the present case, each of the function modules 14, 16, 18, 20 has a plurality of sensors and/or status displays.

As is apparent in FIGS. 1A through 1D, the function modules 14, 16, 18, 20 are essentially completely integrated into an installation space of the housing 4.

Associated with each slot 6, 8, 10, 12 is a pole for connecting a conductor in each case to a cable terminal opening 36, 38, 40, 42 for insertion and clamping of a conductor end. As illustrated for the cable terminal opening 36 by way of example, a screw 44 is used in each case for narrowing the cross section of a cable terminal opening 36, 38, 40, 42.

Each slot 6, 8, 10, 12, in each case with the function module 14, 16, 18, 20 uninstalled, is open toward a cable terminal side 46. Each slot 6, 8, 10, 12 adjoins a metallic contact element 48 that is configured for conducting current during operation of the plug connector 2, as illustrated in FIG. 1D for the slot 6 by way of example. The sensor module with a sensor bar 50 adjoins a contact area 52 in order to detect operating parameters of an electrically conductive plug-in connection during operation of the plug connector 2.

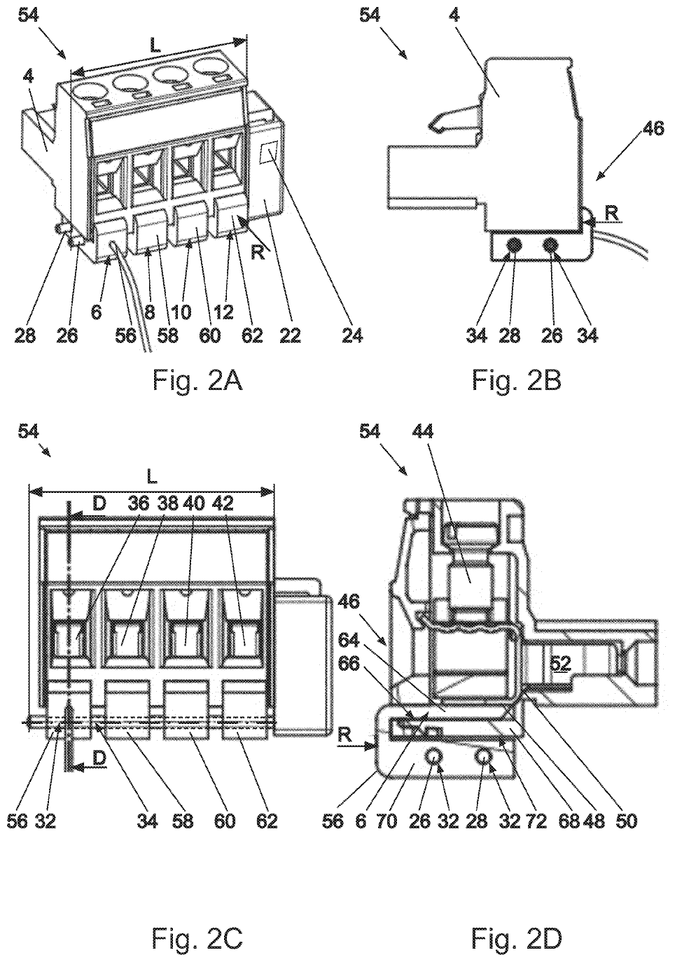

FIG. 2 shows another variant of a plug connector 54 according to the invention. To avoid repetition, the following discussion addresses only differences of the plug connector 54 from the plug connector 2 described above, with identical components or features being denoted by the same reference numerals.

The plug connector 54 has function modules 56, 58, 60, 62, each of which is only partially integrated into the installation space of the housing 4. In particular, the slots 6, 8, 10, 12, observed in a cross section (FIG. 2D), have a narrower design than in the exemplary embodiments described above for FIG. 1.

The function module 56 with a first section 64 adjoins a first side 66 of a housing wall 68 of the housing 4. A second section 70 of the function module 56 is associated with a second side 72 of the housing wall 68 facing away from the first side 66. The second section 70 is not integrated into the installation space of the housing 4.

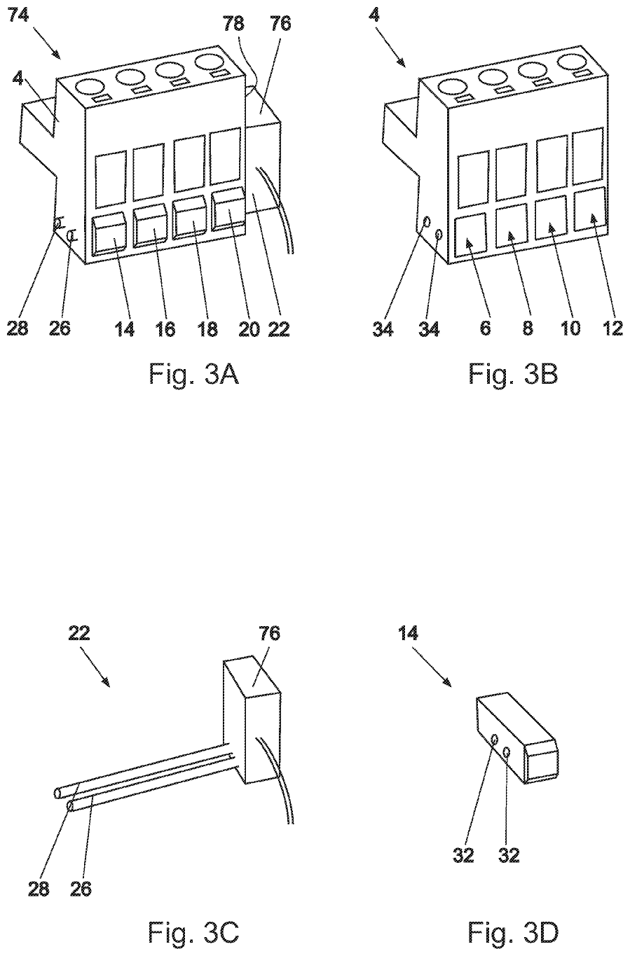

For illustration of the basic design of a plug connector according to the invention, FIG. 3 shows another embodiment of a plug connector 74 according to the invention, illustrated in a greatly simplified manner.

FIG. 3A shows an assembly drawing of the plug connector 74, having a supply unit 22, a housing 4, and four installed function modules 14, 16, 18, 20.

FIG. 3B shows the housing 4 of the plug connector 74 by itself.

FIG. 3C shows the supply unit 22 of the plug connector 74 by itself.

FIG. 3D shows an example of the function module 14 in an isolated illustration. It is understood that the plug connector 74 may be equipped with only a single function module 14, resulting in an at least three-part design of the plug connector 74.

The supply unit 22 has an enclosure 76 within which a microcontroller, an RFID tag, a temperature sensor, a status display, a voltage converter, and an analog/digital converter are accommodated.

The enclosure 76 rests against an outer surface 78 of the housing 4 facing away from the function modules 14, 16, 18, 20. The supply unit 22 is connected to the housing 4 in a form-fit manner.

### LIST OF REFERENCE NUMERALS

2 plug connector
4 housing
6 slot
8 slot
10 slot
12 slot
14 function module/sensor module
16 function module/sensor module
18 function module/sensor module
20 function module/sensor module
22 supply unit
24 control unit
26 molded element/pin
28 molded element/pin
30 line
32 through opening
34 through opening
36 cable terminal opening
38 cable terminal opening
40 cable terminal opening
42 cable terminal opening
44 screw
46 cable terminal side
48 contact element
50 sensor bar
52 contact area
54 plug connector
56 function module/sensor module
58 function module/sensor module
60 function module/sensor module
62 function module/sensor module
64 first section
66 first side
68 housing wall
70 second section
72 second side
74 plug connector
76 enclosure
L longitudinal extension
R insertion direction

What is claimed is:

1. A plug connector, comprising:
a housing that has at least one slot for accommodating an exchangeable function module, wherein the housing is configured for accommodating a supply unit and/or a locking unit in order to fasten the function module to the housing in a form-fit and/or force-fit manner.

2. The plug connector according to claim 1, comprising:
at least one exchangeable function module that is accommodated in the slot; and
an exchangeable supply unit, wherein:
the supply unit is configured for supplying power to the function module and/or for transmitting signals between the function module and a control unit; and
the supply unit has at least one molded element that is configured for fastening the function module to the housing in a form-fit and/or force-fit manner; and/or
the molded element of the supply unit is used for contacting the function module with the supply unit, in particular the molded element being part of a bus system.

3. The plug connector according to claim 1, wherein:
the molded element has at least one pin that is situated in openings in the housing and in the function module; and/or
at least two molded elements are provided that are situated in openings in the housing and in the function module.

4. The plug connector according to claim 3, wherein:
the openings in the housing and in the function module are situated coaxially, or have concentrically situated cross sections, viewed along an axis; and/or
the openings and the pin have a circular cylindrical shape; and/or
a clearance fit is formed between the openings (32, 42) and the pin.

5. The plug connector according to claim 1, wherein:
the function module is insertable into the slot along an insertion direction; and
a longitudinal extension of the molded element is oriented transversely with respect to the insertion direction, essentially orthogonally with respect to the insertion direction.

6. The plug connector according to claim 1, wherein:
the supply unit has a microcontroller; and/or
the supply unit has an RFID tag; and/or
the supply unit has one or more sensors; and/or
the supply unit has a temperature sensor; and/or
the supply unit has a status display such as an LED; and/or
the supply unit has a voltage converter; and/or
the supply unit has an analog/digital converter.

7. The plug connector according to claim 1, wherein:
the function module is a sensor module; and/or
the function module has one or more sensors; and/or
the function module has one or more status displays; and/or
two or more slots and/or function modules are provided.

8. The plug connector according to claim 1, wherein:
the function module is at least partially or completely integrated into an installation space of the housing; and/or
the function module rests with a first section against a first side of a housing wall, and a second section is associated with a second side of the housing wall facing away from the first side, wherein the second section is not integrated into an installation space of the housing.

9. The plug connector according to claim 1, wherein:
the slot is associated with a pole and is open toward a cable terminal side; and/or
the slot adjoins a metallic contact element that is configured for conducting current during operation of the plug connector; and/or
the function module rests against a metallic contact element that is configured for conducting current during operation of the plug connector.

10. The plug connector according to claim 1, wherein:
the supply unit has an enclosure that rests against an outer surface of the housing facing away from the function module; and/or
the supply unit is connected to the housing in a form-fit and/or force-fit manner.
